(19) United States
(12) Patent Application Publication
(10) Pub. No.: US 2025/0147495 A1
(43) Pub. Date: May 8, 2025

(54) DEFECT SIGNIFICANCE IN A MANUFACTURING PROCESS

(71) Applicant: Minitab, LLC, State College, PA (US)

(72) Inventors: Senin J. Banga, State College, PA (US); Cheryl L. Pammer, San Diego, CA (US)

(73) Assignee: Minitab, LLC, State College, PA (US)

(21) Appl. No.: 18/386,480

(22) Filed: Nov. 2, 2023

(51) Int. Cl. G05B 19/418

(52) U.S. Cl. CPC G05B 19/41875; G05B 19/4183

(57) ABSTRACT

An aspect includes inspecting, using a sensor array, a batch of items in a stage of a process for defects that meet a predefined defect criteria, obtaining from the sensor array, a number of items in the batch with the defects, the batch of items is a sample from a population of items. The aspect includes computing a statistical significance level of a difference between a proportion of defects in the stage of the process and a predefined proportion threshold by calculating a p-value of a statistical test about the proportion of the defects through computing a solution to an equation derived from inverting an Agresti-Coull confidence interval for the proportion of defects.

### BACKGROUND

### Technical Field

The present disclosure generally relates to inspecting items in a random sample for defects to make an inference about a proportion of defects in a population of the items, and more particularly, to computing the statistical significance level of a difference between the proportion of defects and a predefined proportion threshold via a defect monitoring system.

### Description of the Related Art

Statistical analysis is an aspect of data-driven procedures across diverse domains, including but not limited to research, engineering, and healthcare. Central to statistical analysis are two fundamental concepts: confidence intervals and p-values. These tools provide important insights into the uncertainty associated with estimates and the significance of observed effects.

### BRIEF SUMMARY

According to an embodiment of the present disclosure, a method is disclosed. The method comprises inspecting, using a sensor array, a batch of items in a stage of a process for defects that meet predefined defect criteria, obtaining from the sensor array, a number of items in the batch that have been determined to have the defects, the batch of items being a sample from a population of items. The method further includes computing a statistical significance level of a difference between the proportion of defects and a predefined proportion threshold by calculating a p-value of a statistical test about the proportion of the defects through computing a solution to an equation derived from inverting an Agresti-Coull confidence interval for the proportion of defects.

In an aspect, the equation is a cubic polynomial. In another similar aspect, the equation is a non-linear equation.

According to an embodiment of the present disclosure, a system is disclosed. The includes a sensor array, and a processor configured to inspect, using the sensor array, a batch of items in a stage of a process for defects that meet a predefined defect criteria, obtain from the sensor array, a number of items in the batch with the defects, the batch of items is a sample from a population of items, and compute a a statistical significance level of a difference between the proportion of defects and a predefined proportion threshold by calculating a p-value of a statistical test about the proportion of the defects through computing a solution to an equation derived from inverting an Agresti-Coull confidence interval for the proportion of defects. A non-transitory computer-readable storage medium may also store a program which, when executed by a computer system, causes the computer system to perform the methods described herein.

### BRIEF DESCRIPTION OF THE DRAWINGS

To easily identify the discussion of any particular element or act, the most significant digit or digits in a reference number refer to the figure number in which that element is first introduced.

FIG. 1 depicts a block diagram of a network of data processing systems in accordance with an illustrative embodiment.

FIG. 2 depicts a block diagram of a data processing system in accordance with an illustrative embodiment.

FIG. 3 depicts a block diagram of a defect monitoring system in accordance with an illustrative embodiment.

FIG. 4 depicts a block diagram of an application in accordance with an illustrative embodiment.

FIG. 5 depicts a flowchart of a routine for computing a likelihood of defects being statistically significant in accordance with an illustrative embodiment.

FIG. 6 depicts a plot comparing p-value functions for score and Agresti-Coull CI based test in accordance with an illustrative embodiment.

FIG. 7 depicts a flowchart of a routine for computing a likelihood of defects being statistically significant in accordance with an illustrative embodiment.

### DETAILED DESCRIPTION

### Overview

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

The illustrative embodiments are related to statistically comparing the proportion of defects in a sample of physical items from a process to a predefined proportion threshold with the aid of one or more inspection devices. The illustrative embodiments recognize that confidence intervals and p-values may be powerful statistical tools that aid manufacturers in ensuring product quality, process optimization, and decision-making. They may enable data-driven approaches to quality control and process improvement, leading to more efficient and cost-effective manufacturing and quality assurance processes in areas such as fault analysis, process comparison, product testing, supplier selection and batch approval.

A confidence interval may be used to quantify the uncertainty around a parameter estimate, such as the mean, variance, or any other population characteristic. The confidence interval defines a range within which the true parameter value is likely to fall with a specified level of confidence, usually expressed as a percentage. The construction of confidence intervals may involve the use of sample data and estimation methods that vary depending on the type of data and the underlying statistical model. P-values, on the other hand, may be used in hypothesis testing to quantify the strength of evidence against a null hypothesis and to determine the statistical significance of an observed effect. A low p-value may indicate strong evidence against the null hypothesis, suggesting that the observed effect is not due to random chance.

P-values may involve a determination of the probability of observing a test statistic as extreme as the one obtained from sample data under the assumption that the null hypothesis is true. These computations may often require reference to probability distributions and can be challenging when dealing with non-standard data such as in a complex manufacturing system.

In general, a confidence interval (CI) method corresponds to a hypothesis testing procedure and vice versa. For example, in the context of estimating a single population proportion, a so called “Wald” CI may correspond to the Wald test; a so called “Wilson” CI may be matched with a “score” test; a so called “Clopper-Pearson” CI may be associated with the exact test for a binomial proportion, etc. The illustrative embodiments recognize that however, for the “Agresti-Coull” (1998) CI method, a matching hypothesis test is unavailable. One appeal of the Agresti-Coull CI is its computational simplicity. As a result, operators may often be forced to use Agresti-Coull confidence interval in conjunction with test procedure that do not match the Agresti-Coull confidence interval, thus yielding conflicting results for manufacturers wherein the Agresti-Coull CI may cover the hypothesized value of the proportion while the p-value of the test may indicate that there is a significant difference between the hypothesized value and the true proportion. For instance, a 100(1−α) percent Agresti-Coull confidence interval may cover the hypothesized value of the unknown proportion while the test p-value may indicate a significant test result at level a. The illustrative embodiments recognize that the consistency between tests and CIs or simply test-CI consistency may be highly valuable since as operators adopt the combining of CIs and p-values of tests. Indeed, a CI may also be used to determine whether or not the corresponding test is significant. Including the p-value may provide a measure of the strength of the evidence (or lack thereof) in the sample data against the null hypothesis. On this basis, despite the appealing properties of CIs, a CI method without the p-value function of the matching hypothesis test is thus incomplete.

The illustrative embodiments disclose the p-value function of the hypothesis test associated with the Agresti-Coull confidence interval in computing a statistical significance level of a difference between the proportion of defects and a predefined proportion threshold in a process via one or more inspection devices at different stages of the process. Advantageously, the test-confidence interval inconsistencies may be obviated and the computational simplicity of the Agresti-Coull CI may be kept.

In one aspect, a method is disclosed comprising inspecting, using a sensor array, a batch of items in a stage of a manufacturing process for defects that meet a predefined defect criteria. The method further comprises obtaining from the sensor array, a number of the defects in the batch of items and computing a statistical significance level of a difference between the proportion of defects and a predefined proportion threshold for the manufacturing process by calculating a p-value of a statistical test about the proportion of the defects in the sample through computing a solution to an equation derived from inverting an Agresti-Coull confidence interval for the proportion of defects. The batch of items may be a sample such as a sample of raw materials or processed materials from a larger population of items.

An embodiment can be implemented as a software and/or hardware application. The application implementing an embodiment can be configured as a modification of an existing system, as a separate application that operates in conjunction with an existing system, a standalone application, or some combination thereof.

This manner of performing the statistical hypothesis test for a proportion of defects based on Agresti-Coull confidence interval is unavailable in the presently available methods in the technological field of endeavor pertaining to processes involving the measurement and monitoring of material parameters via inspection devices and sensor arrays such in manufacturing and in other industrial applications. A method of an embodiment described herein, when implemented to execute on a device or data processing system, comprises substantial advancement of the computational functionality of that device or data processing system in configuring the performance, accuracy, and consistency of a monitoring platform.

The illustrative embodiments are described with respect to certain types of machines developing statistical and predictive models based on data records obtained from material parameter inspection devices. The illustrative embodiments are also described with respect to other scenes, subjects, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

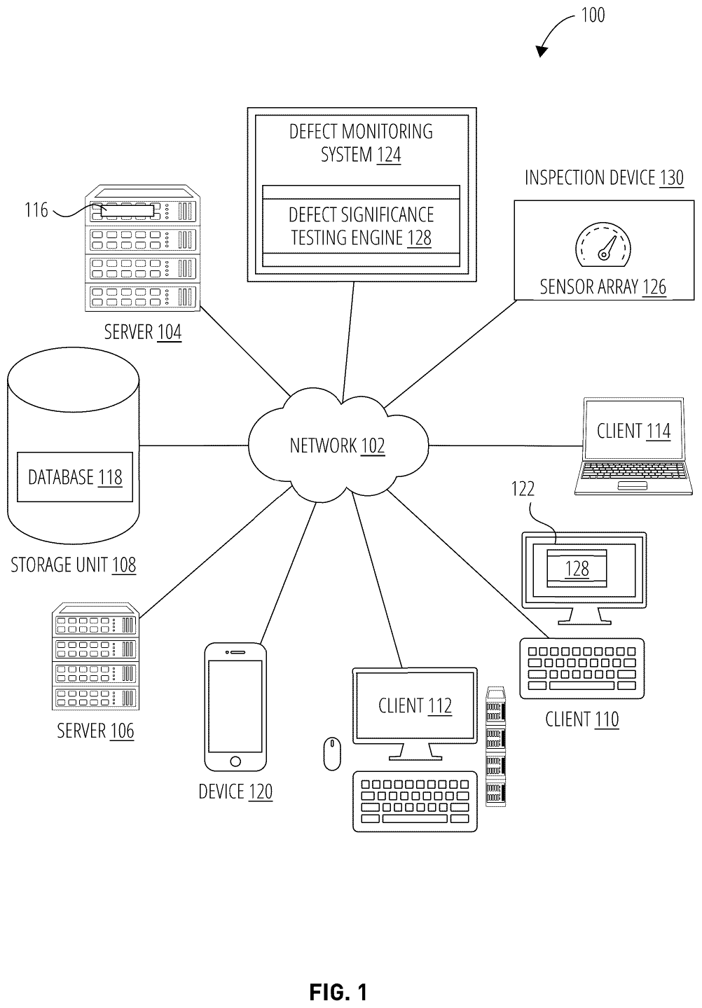

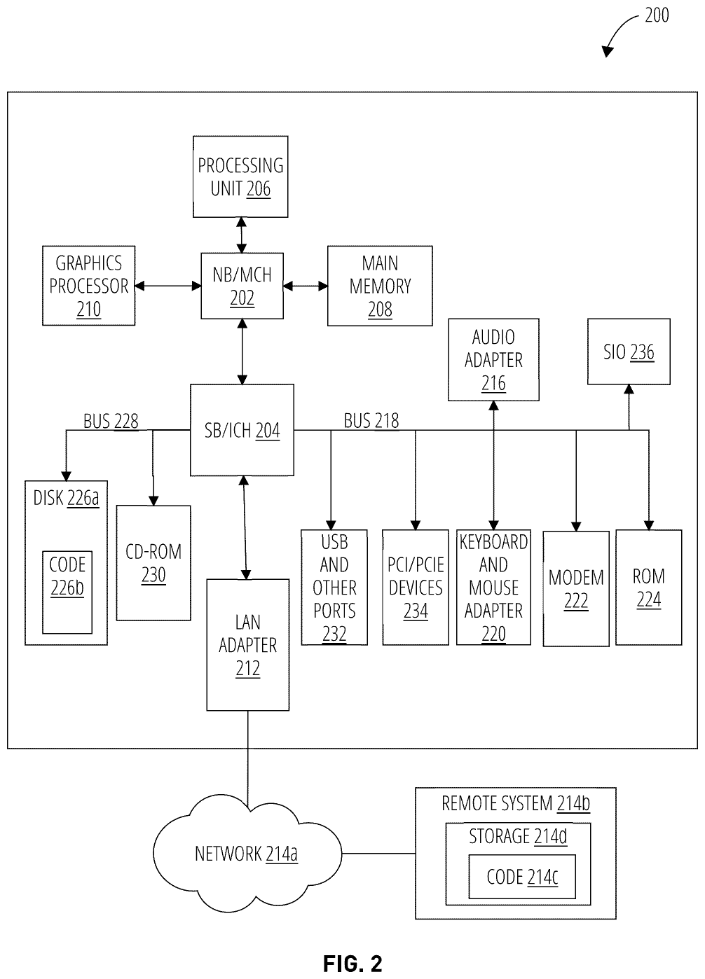

With reference to the figures and in particular with reference to FIG. 1 and FIG. 2, these figures are example diagrams of data processing environments in which illustrative embodiments may be implemented. FIG. 1 and FIG. 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Client 110, client 112, client 114 are also coupled to network 102. A data processing system, such as server 104 or server 106, or clients (client 110, client 112, client 114) may contain data and may have software applications or software tools executing thereon.

Only as an example, and without implying any limitation to such architecture, FIG. 1 depicts certain components that are usable in an example implementation of an embodiment. For example, servers and clients are only examples and not to imply a limitation to a client-server architecture. As another example, an embodiment can be distributed across several data processing systems and a data network as shown, whereas another embodiment can be implemented on a single data processing system within the scope of the illustrative embodiments. Data processing systems (server 104, server 106, client 110, client 112, client 114) also represent example nodes in a cluster, partitions, and other configurations suitable for implementing an embodiment.

Device 120 is an example of a device described herein. For example, device 120 can take the form of a smartphone, a special purpose fabrication platform, a tablet computer, a laptop computer, client 110 in a stationary or a portable form, a wearable computing device, or any other suitable device. Any software application described as executing in another data processing system in FIG. 1 can be configured to execute in device 120 in a similar manner. Any data or information stored or produced in another data processing system in FIG. 1 can be configured to be stored or produced in device 120 in a similar manner.

Defect significance testing engine 128 may execute as part of defect monitoring system 124, client application 122, server application 116 or on any data processing system herein. Defect significance testing engine 128 may also execute as a cloud service communicatively coupled to system services, hardware resources, or software elements described herein. Defect significance testing engine 128 may be operable to compute a likelihood of the defects being statistically significant for the manufacturing process by calculating a p-value of a statistical test for the proportion of the defects in a sample through computing a solution to an equation derived from inverting an Agresti-Coull confidence interval for the proportion of defects. Defect monitoring system 124 may subsequently recommend a course of action for the batch or population of items or materials based on the statistical significance. Database 118 of storage unit 108 stores one or more measurements or data in repositories for computations herein.

Server application 116 implements an embodiment described herein. Server application 116 can use data from storage unit 108 for computations herein. Server application 116 can also obtain data from any client for computations. Server application 116 can also execute in any of data processing systems (server 104 or server 106, client 110, client 112, client 114), such as client application 122 in client 110 and need not execute in the same system as server 104.

Server 104, server 106, storage unit 108, client 110, client 112, client 114, device 120 may couple to network 102 using wired connections, wireless communication protocols, or other suitable data connectivity. Client 110, client 112 and client 114 may be, for example, personal computers or network computers.

In the depicted example, server 104 may provide data, such as boot files, operating system images, and applications to client 110, client 112, and client 114. Client 110, client 112 and client 114 may be clients to server 104 in this example. Client 110, client 112 and client 114 or some combination thereof, may include their own data, boot files, operating system images, and applications. Data processing environment 100 may include additional servers, clients, and other devices that are not shown. Server 104 includes a server application 116 that may be configured to implement one or more of the functions described herein in accordance with one or more embodiments.

Server 106 may include a configuration to aggregate sensor measurements and store a total number of defects in database 118 for automatic computation of p-values.

An operator of the defect monitoring system 124 can include individuals, computer applications, and electronic devices. The operators may employ the defect significance testing engine 128 of the defect monitoring system 124 to make predictions or decisions. An operator may desire that the defect significance testing engine 128 perform methods to satisfy a predetermined evaluation/relevance criteria.

The data processing environment 100 may also be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service-oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as server 104, server 106, client 110, client 112, client 114, device 120, or defect monitoring system 124 in FIG. 1, or another type of device in which computer usable program code or instructions implementing the processes may be located for the illustrative embodiments.

Data processing system 200 is also representative of a data processing system or a configuration therein in which computer usable program code or instructions implementing the processes of the illustrative embodiments may be located. Data processing system 200 is described as a computer only as an example, without being limited thereto. Implementations in the form of other devices, such as device 120 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to North Bridge and memory controller hub (NB/MCH) 202 through an accelerated graphics port (AGP) in certain implementations.

In the depicted example, local area network (LAN) adapter 212 is coupled to South Bridge and input/output (I/O) controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and input/output (I/O) controller hub (SB/ICH) 204 through bus 218. Hard disk drive (HDD) or solid-state drive (SSD) 226a and CD-ROM 230 are coupled to South Bridge and input/output (I/O) controller hub (SB/ICH) 204 through bus 228. PCI/PCIe devices 234 may include, for example, Ethernet adapters, add-in cards, and PC cards for notebook computers. PCI uses a card bus controller, while PCIe does not. Read only memory (ROM) 224 may be, for example, a flash binary input/output system (BIOS). Hard disk drive (HDD) or solid-state drive (SSD) 226a and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and input/output (I/O) controller hub (SB/ICH) 204 through bus 218.

Memories, such as main memory 208, read only memory (ROM) 224, or flash memory (not shown), are some examples of computer usable storage devices. Hard disk drive (HDD) or solid-state drive (SSD) 226a, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as server application 116 and client application 122 in FIG. 1, are located on storage devices, such as in the form of codes 226b on Hard disk drive (HDD) or solid-state drive (SSD) 226a, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory (ROM) 224, or in one or more peripheral devices.

Furthermore, in one case, code 226b may be downloaded over network 214a from remote system 214b, where similar code 214c is stored on a storage device 214d in another case, code 226b may be downloaded over network 214a to remote system 214b, where downloaded code 214c is stored on a storage device 214d.

The hardware in FIG. 1 and FIG. 2 may vary depending on the implementation. Other internal hardware or peripheral devices, such as flash memory, equivalent non-volatile memory, or optical disk drives and the like, may be used in addition to or in place of the hardware depicted in FIG. 1 and FIG. 2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub (NB/MCH) 202. A processing unit may include one or more processors or CPUs.

The depicted examples in FIG. 1 and FIG. 2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and Hard disk drive (HDD) or solid-state drive (SSD) 226a is manifested as a virtualized instance of all or some portion of Hard disk drive (HDD) or solid-state drive (SSD) 226a that may be available in the host data processing system. The host data processing system in such cases is represented by data processing system 200.

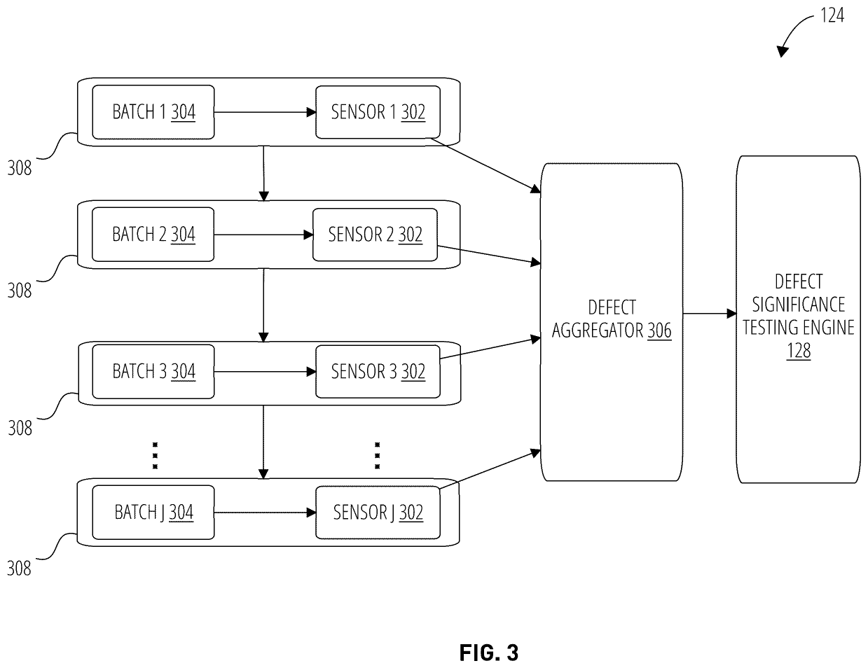

Turning now to FIG. 3, a block diagram of a defect monitoring system 124 for identifying a proportion of defects that is statistically significantly different than a predefined proportion threshold is illustrated. The system comprises one or more sensors 302 that form a sensor array 126, materials or items grouped into one or more samples as batches 304, and a defect aggregator 306 configured to store a total number of defects detected or measured in a batch 304 in any stage 308 of the process. The process may comprise one or more stages 308, such as “J” stages where j>1. A defect significance testing engine 128 may be operable to compute the p-value of the hypothesis test associated with the Agresti-Coull confidence interval.

More specifically, monitoring the proportion of defective materials in a process such as a manufacturing or quality assurance process, and only taking corrective action when statistical evidence exists suggesting that the population proportion of defective materials is above a target level prevents the excessive variation that occurs when a process is constantly tweaked. A 1-sample test of proportions may determine whether the population proportion of defective items has significantly increased above a target defect level, such as the defective proportion of 0.0000034 that corresponds to a Six Sigma level process. The true population proportion of defective items is likely to be close to zero therefore a better alternative confidence interval method over the more conservative Clopper-Pearson exact method and the more liberal Wilson/score method may be the Agresti-Coull confidence interval. For example, if 4 defective items are found out of 495,995 manufactured units during a manufacturing process, the Agresti-Coull 95% lower bound on the proportion defective is 0.0000031 indicating that the population proportion defective is unlikely to have exceeded the target of 0.0000034. The illustrative embodiments recognize that if the Agresti-Coull confidence interval result was combined with the score test (the test associated with the Wilson confidence interval) result, the p-value for the score test of 0.037 would conflict with the Agresti-Coull confidence interval result. In addition, this p-value would suggest that the proportion of defective is greater than the target proportion of defects at the 0.05 level of significance and may cause a manufacturer to put in place unnecessary expensive corrective measures. As shown herein, by computing a p-value that is consistent with the Agresti-Coull confidence interval result, a value of 0.063 may be obtained suggesting that no corrective measures should be taken at the 0.05 level of significance.

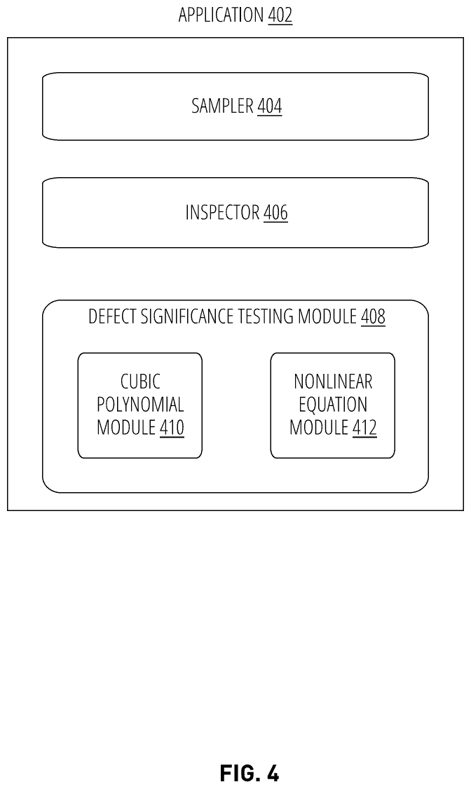

The defect monitoring system 124 of FIG. 3 may work in conjunction with the application 402 of FIG. 4 which may be an example of defect significance testing engine 128, server application 116 or client application 122 of FIG. 1.

The application 402 comprises a sampler 404 configured to obtain a sample from a population of items for inspection, and an inspector 406 configured to inspect, via an inspection device 130, defects present in the sample. The application may also comprise a defect significance testing module 408 which may be operable to perform a statistical hypothesis test via a cubic polynomial module 410 which yields an analytical expression of the p-value function in terms of a specific real root of a cubic polynomial, or equivalently via the unique root of a nonlinear equation module 412 which provides the p-value as a function of the unique solution of a simple nonlinear equation. Advantageously, the two approaches may be mathematically equivalent and are described herein.

The embodiments recognize that a binomial distribution may be adopted for making inference about an unknown proportion, p, of items in a population with a specific trait of interest. An approach for estimating the unknown proportion, p, may begin with the selection of a random sample (batch 304) of size n drawn from a target population. By letting X be the number of items with the characteristic of interest in the selected random sample, X is thus, a binomial random variate with parameters n and p. x may be the observed value of the random variate X, i.e., the number of events of interest, (0≤x≤n). For example, x is the observed number of defective items in a randomly selected sample in the population of all the items. \hat{p}=x/n may be the observed proportion of the defects of interest. It may be proven that \hat{p} is the maximum likelihood estimate of the unknown proportion p. An interval estimation method for p, is the Agresti-Coull CI. A two-sided 100(1−α) percent Agresti-Coull CI for p is given as:

$$\tilde{p} \pm {z}_{α / 2} \sqrt{\frac{\tilde{p} ( 1 - \tilde{P} )}{n + {z}_{α / 2}^{2}}} ,$$

where, in general, zₚ is the upper q percentile point of the standard normal distribution. In addition, \tilde{p} is given as follows:

$$\tilde{p} = \frac{2 x + {𝓏}_{α / 2}^{2}}{2 ( n + {𝓏}_{α / 2}^{2} )} .$$

Let p₀ be given and fixed (0<p₀<1). It is clear that T_{α}=(\tilde{p}−p₀)\sqrt{n+z_{α/2}²}/\sqrt{\tilde{p}(1−\tilde{p})} may not be a proper test statistic because it depends on α. Therefore, there a straightforward method for calculating the p-value of the test associated with the Agresti-Coull CI may be elusive, except by inverting the CI procedure. Specifically, by a duality principle, the two-tailed hypothesis test with level of significance α associated with the two-sided 100(1−α) percent Agresti-Coull CI rejects the null hypothesis H₀:p=p₀ in favor of the alternative hypothesis Hₐ:p≠p₀ if, and only if, the CI does not cover p₀. Equivalently,

$$\vert \tilde{p} - {p}_{0} \vert \geq {𝓏}_{α / 2} \sqrt{\frac{\tilde{p} ( 1 - \tilde{p} )}{n + {𝓏}_{α / 2}^{2}}} .$$

Since the p-value of a test is the smallest level of significance α for which the sample at hand yields a rejection of H₀, the p-value of the two-tailed test corresponding to a two-sided Agresti-Coull CI is the value of α′ that satisfies the following equation.

$$\vert \tilde{p} - {p}_{0} \vert \geq {𝓏}_{{α}^{′} / 2} \sqrt{\frac{\tilde{p} ( 1 - \tilde{p} )}{n + {𝓏}_{{α}^{′} / 2}^{2}}} .$$

The p-value, α′, is derived in the following two steps.

Firstly, let z=z_{α′/2}=Φ⁻¹(1−α′/2) and solve the following equation for z.

$$\vert \tilde{p} - {p}_{0} \vert = 𝓏 \sqrt{\frac{\tilde{p} ( 1 - \tilde{p} )}{n + {𝓏}^{2}}} , where \tilde{p} = \frac{2 x + {𝓏}^{2}}{2 ( n + {𝓏}^{2} )} \qquad ( 1 )$$

Secondly, by noting that if z₀ is a solution of equation (1) then so is its opposite, −z₀, the p-value of the two-tailed test associated with the Agresti-Coull CI is obtained as α′=2[1−Φ(|z₀|)], by symmetry.

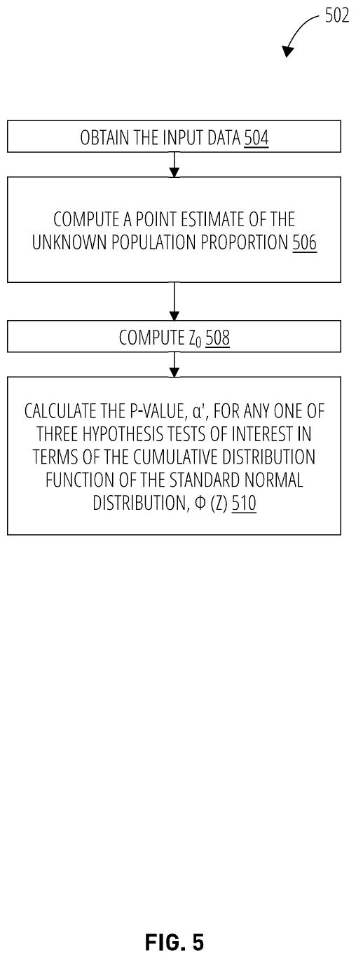

The p-values associated with the one-sided alternatives Hₐ:p>p₀ and Hₐ:p<p₀ are also provided herein. The approaches described herein may prove the existence of and find the solutions z₀ and −z₀ through a generalized routine 502 as shown in FIG. 5. The routine 502 may begin at block 504 wherein an input data is obtained, the input data comprising sample size n: sample size (n>0), a number of events of interest x:(0≤x≤n), a hypothesized proportion of events p₀, and an alternative type wherein an input value is 0 for the two-sided alternative Hₐ:p≠p₀; its value is 1 if Hₐ:p>p₀ and −1 if Hₐ:p<p₀. The routine 502 further includes computing a point estimate of the unknown population proportion \hat{p}=x/n at block 506, computing z₀ at block 508, and computing the p-value, α′, for three different hypothesis tests in terms of the cumulative distribution function of the standard normal distribution, φ (z) at block 510.

The routine 502 is further described for the first approach, as implemented by the cubic polynomial module 410, wherein a close-form expression of z₀ is obtained. By squaring both sides of equation (1), the following equivalent equation may be obtained:

$${( \tilde{p} - {p}_{0} )}^{2} = {𝓏}^{2} \frac{\tilde{p} ( 1 - \tilde{p} )}{n + {𝓏}^{2}} . \qquad ( 1.1 )$$

Since n−2x=0 is equivalent to \hat{p}=\tilde{p}=½, if n−2x=0 equation (1.1) reduces to the following: (1−2p₀)² (n+z²)=z². It follows that if \hat{p}=\tilde{p}=½ then the solution z₀ is given by the following close-form expression:

$${𝓏}_{0} = \frac{1}{2} \vert 1 - 2 {p}_{0} \vert \sqrt{\frac{n}{{p}_{0} ( 1 - {p}_{0} )}} . \qquad ( 1.2 )$$

Assuming that \hat{p}≠½, or equivalently \tilde{p}≠½, one may let y≡\tilde{p} and re-express z² in equation (1.1) in terms of y as follows:

$${𝓏}^{2} = \frac{2 ( ny - x )}{1 - 2 y} \qquad ( 1.3 )$$

z² is well-defined since its denominator is always nonzero by the condition y≡\tilde{p}≠½. Thus, equation (1.1) can be re-expressed as a cubic polynomial in y ≡\hat{p} as follows.

$$H ( y ; \hat{p} , {p}_{0} ) ≡ 2 {y}^{3} - ( 1 + 4 \hat{p} ) {y}^{2} + 2 [ ( 2 \hat{p} - 1 ) {p}_{0} + \hat{p} ] y + ( 1 - 2 \hat{p} ) {p}_{0}^{2} = 0 \qquad ( 1.4 )$$

Further, for given x, n>0, (0≤x≤n) and p₀, H(y;\hat{p},p₀) is a proper cubic polynomial in y because of the assumption that \hat{p}≠½. Thus, the solution, z₀, of equation (1) amounts to finding the appropriate root, y₀, of H(y;\hat{p},p₀) that satisfies the following condition:

$${𝓏}_{0}^{2} = \frac{2 ( {ny}_{0} - x )}{1 - 2 {y}_{0}} \geq 0 \qquad ( 1.5 )$$

It is straightforward to see that the above condition is satisfied if, and only if, either \hat{p}≤y₀<½ or ½<y₀≤\hat{p}. Since the coefficients of H(y;\hat{p}, p₀) are all real numbers, from well-known results about cubic polynomials, H(y; \hat{p}, p₀) has three roots: and it follows that either all the three roots are real numbers, or one root is a real number and the other two are complex numbers. Furthermore, it follows that the second largest of those roots may be the only one that satisfies the criteria (1.5) and is expressed trigonometrically as follows:

$${y}_{0} = 2 \sqrt{- \frac{λ}{3}} cos [ arccos ( \frac{3 γ}{2 λ} \sqrt{- \frac{3}{λ}} ) - \frac{2 π}{3} ] + \frac{1 + 4 \hat{p}}{6} , where$$

$$λ = \hat{p} + 2 \hat{p} {p}_{0} - {p}_{0} - \frac{{( 1 + 4 \hat{p} )}^{2}}{12} , γ = \frac{54 ( 1 - 2 \hat{p} ) {p}_{0}^{2} + 18 ( 1 + 4 \hat{p} ) ( \hat{p} + 2 \hat{p} {p}_{0} - {p}_{0} ) - {( 1 + 4 \hat{p} )}^{3}}{108} .$$

By combining the solutions of equations (1.1) for the case where p=½ and the current case where \hat{p}≠½, the solution z₀ of equation (1) can be summarized as follows.

$${z}_{0} = \{ \begin{matrix}0 , & \hat{p} = {p}_{0} \\ \frac{( 1 - 2 {p}_{0} )}{2} \sqrt{\frac{n}{{P}_{0} ( 1 - {P}_{0} )}} , & \hat{p} = \frac{1}{2} > {p}_{0} \\ - \frac{( 1 - 2 {p}_{0} )}{2} \sqrt{\frac{n}{{P}_{0} ( 1 - {P}_{0} )}} , & \hat{p} = \frac{1}{2} < {p}_{0} \\ \sqrt{\frac{2 ( {ny}_{0} - x )}{( 1 - 2 {y}_{0} )}} , & \hat{p} \neq \frac{1}{2} , \hat{p} > {p}_{0} \\ - \sqrt{\frac{2 ( {ny}_{0} - x )}{( 1 - 2 {y}_{0} )}} , & \hat{p} \neq \frac{1}{2} , \hat{p} < {p}_{0}\end{matrix}$$

where y₀, λ and γ are as previously given. Thus, the p-value of the two-tailed test H₀:p=p₀ versus Hₐ:p≠p₀ is calculated as follows: α′=2[1−Φ(|z₀|)], where z₀ is as previously given. It follows immediately that the p-values of the one-tailed tests H₀:p=p₀ versus Hₐ:p>p₀ and H₀:p=p₀ versus Hₐ:p<p₀ are given by α′=1−Φ(z₀) and α′=Φ(z₀), respectively.

The routine 502 is further described for the second approach, as implemented by the nonlinear equation module 412, wherein z₀ is obtained by a numerical method. Equation (1) is also equivalent to the following:

$$L ( 𝓏 ; x , n , {p}_{0} ) ≡ 2 x + {𝓏}^{2} - 𝓏 \sqrt{\frac{( 2 x + {𝓏}^{2} ) ( 2 n - 2 x + {𝓏}^{2} )}{n + {𝓏}^{2}}} - 2 {p}_{0} ( n + {𝓏}^{2} ) = 0 ,$$

$$or U ( 𝓏 ; x , n , {p}_{0} ) = 2 x + {𝓏}^{2} + 𝓏 \sqrt{\frac{( 2 x + {𝓏}^{2} ) ( 2 n - 2 x + {𝓏}^{2} )}{n + {𝓏}^{2}}} - 2 {p}_{0} ( n + {𝓏}^{2} ) = 0$$

Moreover, for a given x, n>0, (0≤x≤n) and p₀, U(z; x, n, p₀)=L(−z; x, n, p₀). Thus, if z₀ is a solution of the equation L(z; x, n, p₀)=0 then its opposite, −z₀, is also a solution of the equation U(z; x, n, p₀)=0. Therefore, to find the solutions, z₀, of the above two equations one of them may be solved. For the first equation

$$L ( 𝓏 ; x , n , {p}_{0} ) ≡ 2 x + {𝓏}^{2} - 𝓏 \sqrt{\frac{( 2 x + {𝓏}^{2} ) ( 2 n - 2 x + {𝓏}^{2} )}{n + {𝓏}^{2}}} - 2 {p}_{0} ( n + {𝓏}^{2} ) = 0 \qquad ( 2.1 )$$

The function L(z; x, n, p₀) has a unique root. For a given x, n>0, (0≤x≤n), and p₀ L(z; x, n, p₀)˜z²−z|z|−2p₀z² as z→∞. Therefore,

$${lim}_{𝓏 \to - ∞} L ( 𝓏 ; x , n , {p}_{0} ) = - {lim}_{𝓏 \to ∞} L ( 𝓏 ; x , n , {p}_{0} ) = + ∞ .$$

In addition, for a given x, n>0, (0≤x≤n), and p₀ fixed, L(z; x, n, p₀) is a monotone decreasing function of z. Thus, given x, n>0, (0≤x≤n) and p₀, L(z; x, n, p₀) decreases from +∞ to −∞ as z varies from −∞ to +∞. In addition, L(0; x, n, p₀)=2(x−np₀). Therefore, by the intermediate-value theorem,

$$\{ \begin{matrix}{𝓏}_{0} = 0 , & \hat{p} = {p}_{0} \\ {𝓏}_{0} < 0 , & \hat{p} < {p}_{0} \\ {𝓏}_{0} > 0 & \hat{p} > {p}_{0}\end{matrix} .$$

Moreover, since Wilson CIs are contained in Agresti-Coull CIs, the p-value function of the matching test to the Wilson CI (score test) is always less than or equal to the p-value function of the matching test to the Agresti-Coull CI. Thus, the observed value of the well-known Z-score given by zₛ=(\hat{p}−p₀)\sqrt{n}/\sqrt{p₀(1−p₀)}can be used to bracket z₀. Specifically, using a root finding routine, such as the Newtown-Raphson method, a simple algorithm for finding the solution z₀ of equation (2.1) is as follows: Calculate \hat{p}=x/n.

If \hat{p}=p₀ then z₀=0

If \hat{p}<p₀ then search the solution, z₀, of equation (2.1) in the interval [zₛ, 0)

If \hat{p}>p₀ then search the solution, z₀, of equation (2.1) in the interval in the interval (0, z₈]

As before, the p-value of the two-tailed test H₀:p=p₀ versus Hₐ:p≠p₀ is computed as α′=2[1−Φ(|z₀|)]. For one-sided alternatives in the direction where p>p₀, the p-value is given by α′=1−Φ(z₀). On the other hand, for one-sided alternatives in the direction where p<p₀, the p-value is given by α′=Φ(z₀).

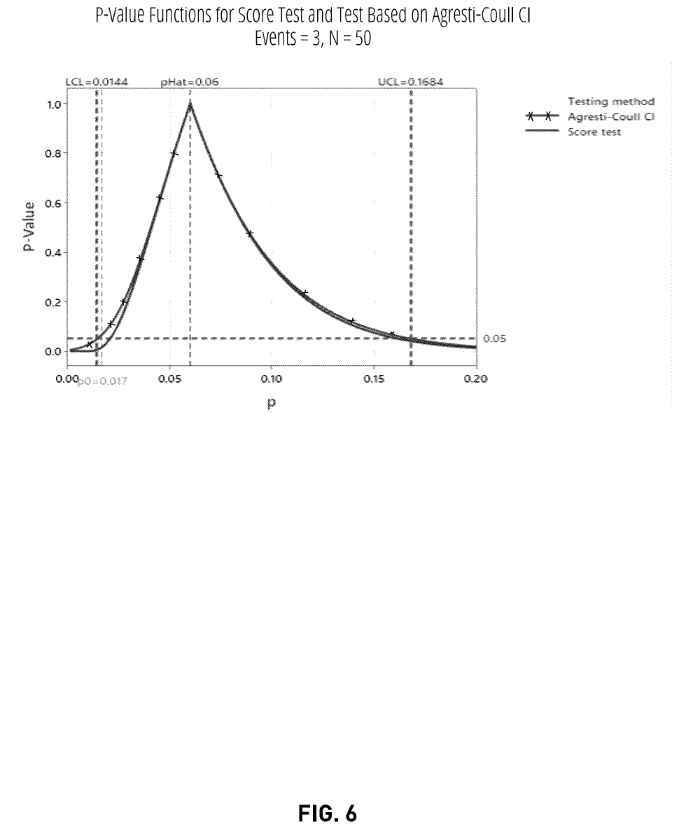

FIG. 6 shows a comparison of the P-value for the score test, and the p-value of the test associated with the Agresti-Coull CI disclosed herein, as functions of the binomial proportion p. In this illustrative example, the number of defects is x=3 and the sample size is n=50. Overall, the p-value function of the test corresponding to the Agresti-Coull CI is greater than or equal to the p-value function of the score test. This is expected since Wilson CIs are always contained in the Agresti-Coull CIs. FIG. 6 further illustrates the duality of CIs and hypothesis tests: the p-value function of the test associated with Agresti-Coull CI is obtained by inverting Agresti-Coull CI; conversely, the p-value function can also be inverted to obtain the Agresti-Coull CI. As shown on the graph, a 95 percent Agresti-Coull CI is the interval defined by the points p such that the p-value function of the test corresponding to the Agresti-Coull CI is greater than α=0.05. As expected, the CI obtained by inverting the p-value function is identical to the CI calculated directly using the Agresti-Coull CI formula.

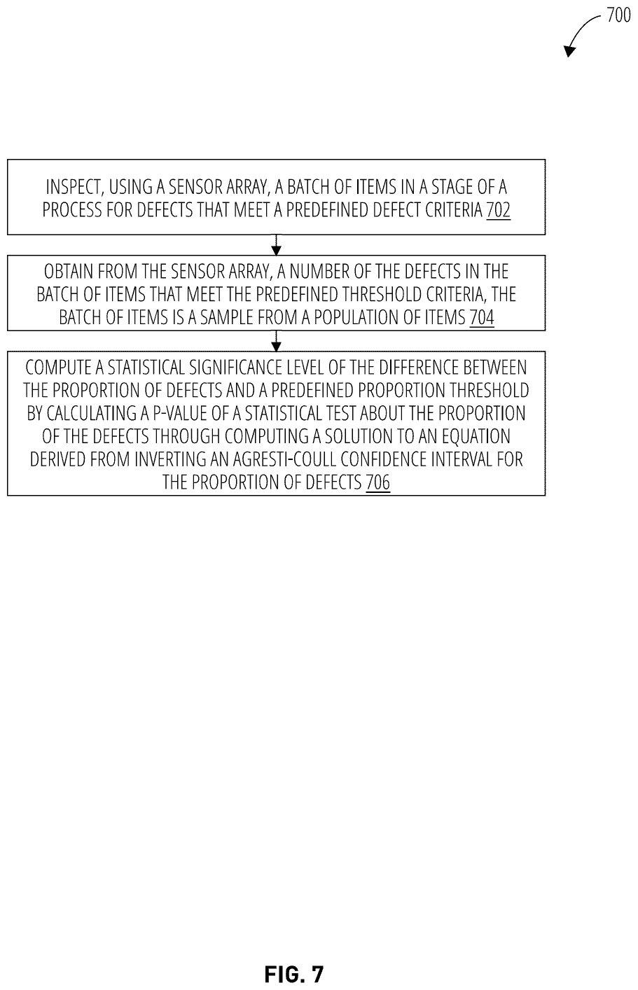

FIG. 7 illustrates a routine 700 for statistically comparing the proportion of defects to a predefined proportion threshold in a manufacturing process. The routine 700 may be performed with the defect significance testing engine 128 of FIG. 1. The routine may further be performed fully or partially automatically. In block 702, the defect significance testing engine 128 inspects, using a sensor array 126, a batch 304 of items, in a specified stage of a manufacturing process, for defects that meet a predefined defect criteria. A defect may be defined in terms of, for example, color variations in the batch of items, scratches, printing artifacts, presence of impurities, etc. In block 704, the defect significance testing engine 128 obtains from the sensor array 126, a number of the defects in the batch 304 of items that meet the predefined threshold criteria, the batch of items is a sample from a population of items. In block 706, the defect significance testing engine 128 computes a statistical significance level of a difference between the proportion of defects and a predefined proportion threshold by calculating a p-value of a statistical test about the proportion of the defects through computing a solution to an equation derived from inverting an Agresti-Coull confidence interval for the proportion of defects. Upon detecting that the proportion of defects is significantly greater than the predefined proportion threshold, a first decision about the population of items may be made. For example, the batch 304 and the population of items may be discarded. Further, upon detecting that the proportion of defects is not statistically greater than the predefined proportion threshold, a second decision about the batch 304 and the population of items may be made. For example, the next stage in the manufacturing process may be performed. In an aspect, the defect significance testing engine 128 may compute the p-value of the statistical test that compares the proportion of defects to the predefined threshold for a plurality of different stages of the manufacturing process.

Any specific manifestations of these and other similar example processes are not intended to be limiting to the invention. Any suitable manifestation of these and other similar example processes can be selected within the scope of the illustrative embodiments.

Thus, a computer implemented method, system or apparatus, and computer program product are provided in the illustrative embodiments for statistically comparing a proportion of defects to a predefined proportion threshold and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser, or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on a dedicated system or user's computer, partly on the user's computer or dedicated system, as a stand-alone software package, partly on the user's computer and partly on a remote computer or entirely on the remote computer or server, etc. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

What is claimed is:

1. A method comprising:
inspecting, using a sensor array, a batch of items in a stage of a process for defects that meet a predefined defect criteria;
obtaining from the sensor array, a number of items in the batch with the defects, the batch of items is a sample from a population of items;
computing a statistical significance level of a difference between a proportion of defects in the stage of the process and a predefined proportion threshold by calculating a p-value of a statistical test about the proportion of the defects through computing a solution to an equation derived from inverting an Agresti-Coull confidence interval for the proportion of defects.

2. The method of claim 1, further comprising: abandoning the plurality of items responsive to computing statistical evidence that the proportion of defects exceeds the predefined proportion threshold.

3. The method of claim 1, wherein the equation is an underlying equation for computing the p-value and wherein the equation is a cubic polynomial.

4. The method of claim 3, wherein the root of the cubic polynomial is computed by computing a point estimate of an unknown population proportion.

5. The method of claim 4, wherein the root of the cubic polynomial is further computed in terms of a cumulative distribution function of a standard normal distribution.

6. The method of claim 1, wherein the equation is an underlying equation for computing the p-value and wherein the equation is a non-linear equation.

7. The method of claim 6, the root of the non-linear equation is computed by computing a point estimate of an unknown population proportion.

8. The method of claim 7, wherein the root of the non-linear equation is further computed in terms of a cumulative distribution function of a standard normal distribution.

9. The method of claim 1, wherein the process is a manufacturing process.

10. The method of claim 9, wherein the inspecting, obtaining, and computing the statistical significance level are performed in a plurality of different stages of the manufacturing process.

11. A system comprising:
a sensor array;
a processor configured to:
inspect, using the sensor array, a batch of items in a stage of a process for defects that meet a predefined defect criteria;
obtain from the sensor array, a number of items in the batch with the defects, the batch of items is a sample from a population of items;
compute a statistical significance level of a difference between a proportion of defects in the stage of the process and a predefined proportion threshold by calculating a p-value of a statistical test about the proportion of the defects through computing a solution to an equation derived from inverting an Agresti-Coull confidence interval for the proportion of defects.

12. The system of claim 11, wherein the processor is further configured to abandon the plurality of items responsive to computing that the likelihood exceeds another predefined threshold criteria.

13. The system of claim 11, wherein the equation is an underlying equation for computing the p-value and wherein the equation is a cubic polynomial, and the processor is further configured to compute the root of the cubic polynomial by computing a point estimate of an unknown population proportion.

14. The system of claim 13, wherein the processor is further configured to compute the root of the cubic polynomial in terms of a cumulative distribution function of a standard normal distribution.

15. The system of claim 11, wherein the equation is an underlying equation for computing the p-value and wherein the equation is a non-linear equation, and the processor is further configured to compute the root of the non-linear equation by computing a point estimate of an unknown population proportion.

16. The system of claim 15, wherein the processor is further configured to compute the root of the non-linear equation in terms of a cumulative distribution function of a standard normal distribution.

17. A non-transitory computer-readable storage medium storing a program which, when executed by a computer system, causes the computer system to:
inspect, using a sensor array, a batch of items in a stage of a process for defects that meet a predefined defect criteria;
obtain from the sensor array, a number of items in the batch with the defects, the batch of items is a sample from a population of items;
compute a statistical significance level of a difference between a proportion of defects in the stage of the process and a predefined proportion threshold by calculating a p-value of a statistical test about the proportion of the defects through computing a solution to an equation derived from inverting an Agresti-Coull confidence interval for the proportion of defects.

18. The non-transitory computer-readable storage medium of claim 17, wherein the program, when executed by the computer system, causes the computer system to:
abandon the plurality of items responsive to computing statistical evidence that the proportion of defects exceeds the predefined proportion threshold.
